(19) United States
(12) Patent Application Publication
(10) Pub. No.: US 2025/0346528 A1
(43) Pub. Date: Nov. 13, 2025

(54) SELF-PRIMING JOINT COMPOUND

(71) Applicant: United States Gypsum Company, Chicago, IL (US)

(72) Inventors: Rafael Bury, Wheeling, IL (US); Buddhabhushan Pundlik Salunkhe, Kenosha, WI (US); Tyler Jared Kincaid, Wheaton, IL (US)

(21) Appl. No.: 18/944,650

(22) Filed: Nov. 12, 2024

Related U.S. Application Data
(60) Provisional application No. 63/644,665, filed on May 9, 2024.

(51) Int. Cl. C04B 14/22; C04B 14/28; C04B 16/06; C04B 20/00

(52) U.S. Cl. CPC C04B 14/22; C04B 14/28; C04B 16/0675; C04B 20/0036; C04B 20/004

(57) ABSTRACT

Methods for installation, repair and finishing of interior walls and ceilings by applying a coating of a self-priming joint compound containing at least a first filler having a particle size distribution with a median particle diameter (D50) in the range from about 18 μm to about 65 μm, a second filler having a particle size distribution with a median particle diameter (D50) in the range from about 0.6 μm to about 25 μm, wherein a ratio of the first filler to the second filler is in the range from 1:2 to 1:10 by weight; a polymeric binder; a thickener and a rheology modifier.

### CROSS-REFERENCE TO RELATED APPLICATIONS

This application claims the benefit of priority from U.S. provisional patent application 63/644,665 filed May 9, 2024, the entire disclosure of which is herein incorporated by reference in its entirety.

### TECHNICAL FIELD

This disclosure relates to joint compound compositions having a self-priming property and methods for installation, repair and finishing of interior walls and ceilings.

### BACKGROUND

Commonly used in construction of interior walls and ceilings, drywall panels are typically flat panels composed of a gypsum core sandwiched between two paper sheets, examples of which can be found in U.S. Pat. Nos. 11,002,010 and 11,702,373. During construction of interior walls, installation techniques may include attaching (hanging) drywall panels to a frame, e.g., to a wood or metal frame, with fasteners, screws and/or nails, but other methods may be also used. While new interior walls can be constructed relatively quickly by hanging drywall panels, several days may be necessary in order to prepare (finish) seams between hung drywall panels in order to produce an interior wall with even texture and ready to receive a paint coating or some other decorative finish.

During this time-consuming finishing process, a seam (joint) between two adjacent drywall panels may be fortified with a tape and filled in with a joint compound, for example as described in U.S. Pat. No. 9,249,578. This first coat of joint compound is allowed to dry, preferably overnight, and then it is sanded. The sanded surface may need to be dedusted. If a joint compound shrinks, a second coat of the joint compound is applied and allowed to dry, preferably overnight, and sanded again. In order to achieve a level 4 finish, a third coat of the same or different joint compound and subsequent sanding and dedusting of the sanded surface may be needed.

Depending on the level of a drywall finish, it may be necessary to produce a wall or ceiling with a smooth, uniform surface, which may require additional steps in order to even a texture between joint-compound filled joints and the rest of the drywall surface. This may be accomplished by applying an additional thin layer of a primer coating over the entire surface of the drywall, for example, as described in U.S. Pat. No. 9,919,969. However, a primer coating may be applied only after a joint compound has dried and sanded and therefore, applying a primer coating may delay completion of interior wall installation or repair.

Thus, there remains the need in the field for joint compounds with self-priming properties such that interior wall installation and repairs may be completed without using a primer coating.

### SUMMARY

At least some of these needs are met by a self-priming joint compound compositions and methods according to this disclosure.

In one aspect, this disclosure relates to a composition for a self-priming joint compound, the composition comprising:
a) a first filler having a particle size distribution with a median particle diameter (D50) in the range from about 18 μm to about 65 μm;
b) a second filler having a particle size distribution with a median particle diameter (D50) in the range from about 0.6 μm to about 25 μm;
   wherein a ratio of the first filler to the second filler is in the range from 1:2 to 1:10 by weight;
c) a polymeric binder;
d) a thickener; and
e) a rheology modifier.

In some embodiments of the composition, the first filler may be hydrophobic, the second filler may be hydrophilic and/or the composition may further comprise a defoamer.

Some embodiments of the composition include those in which the first filler may be in an amount from about 2 to about 50 wt %; the second filler may be in an amount from about 40 to about 95 wt %; the polymeric binder may be an amount from about 0.5 wt % to about 50 wt %; the thickener may be in the amount from about 0.05 wt % to about 5 wt % and a rheology modifier may be in an amount from about 0.05 wt % to about 5 wt %.

In particularly preferred embodiments, the composition may further comprise a defoamer in an amount from about 0.1 wt % to about 1 wt %.

In some particularly preferred embodiments, the first filler may comprise hollow glass microspheres and/or the second filler may comprise calcium carbonate particles, and preferably wherein the hollow glass microspheres may be defined by one or more of the following features:
the hollow glass microspheres are soda-lime borosilicate glass microspheres;
the hollow glass microspheres have a density in the range from about 0.30 g/cc to about 1.5 g/cc;
the hollow glass microspheres are coated with a hydrophobic coating; and/or
the hollow glass microspheres have a D50 of about 40 μm.

In embodiments, the ratio of the first filler to the second filler may be about 1:8 by weight.

Optionally, the compositions according to this disclosure may further comprise one or more of the following additives: a pigment, clay, biocide, fungicide, humectant, dedusting agent, dispersing agent, a color changing indicator, or any combination thereof.

Preferred compositions may include a latex or natural binder which may be starch.

In some embodiments, the compositions may further comprise water in a weight ratio of dry components to water in the range from 3:7 to 9:1, respectively.

In another aspect, this disclosure includes the self-priming joint compound composition which is mixed with water in a weight ratio from about 3:7 to about 9:1, respectively.

In yet another aspect, this disclosure relates to a method for installation, repair and/or finishing a substrate having a surface, the method comprising a step of coating the substrate surface with the coating according to this disclosure. Preferred substrates may include a drywall panel, concrete, cinder block, form concrete, a seam between two adjacent drywall panels attached to a frame, or any combination thereof. In embodiments, the coating may be applied by one or more of the following: a drywall knife, hawk and trowel, roller, brush, or by spraying.

In some embodiments of the method, after the step of applying the coating, the substrate is coated with a paint coating, which may include a semi-gloss or gloss paint coating. The paint coating may include any of the following: a latex paint coating, a water-based or solvent-based epoxy paint coating and/or alkyd/oil based paint coating.

In some embodiments, the method may further comprise sanding the coating after the coating has dried.

In yet another aspect, this disclosure relates to a kit comprising a measured amount of the composition according to this disclosure and a user instruction manual.

### BRIEF DESCRIPTION OF THE DRAWINGS

FIG. 1 is a flowchart of one embodiment for a drywall finishing method according to this disclosure (the right panel) in comparison to a conventional installation method (the left panel).

### DETAILED DESCRIPTION

In one aspect, this disclosure provides a joint compound composition which after its application to a drywall substrate and drying, has an optimized porosity, producing a surface of even texture to which a paint coating may be applied without the need for applying a polymeric primer coating. Other technical advantages of the joint compound composition include, but are not limited to, the enhanced packing ability due to the effect of a filler shape and size to create optimized or low porosity, smaller pore size, that helps with better mechanical strength and lowers roughness. Application by spraying further helps with achieving optimized packing and optimized performance.

In another aspect, this disclosure provides methods for installation, repair and/or finishing and painting various substrates, including concrete, cinder blocks and drywall panels, the methods comprising coating the inventive self-priming joint compound composition mixed with water over at least a portion of the substrate, preferably a drywall panel surface and/or over a seam between two adjacent drywall panels attached to a frame.

In this disclosure, “wt %” means percentage by weight. In this disclosure, all percentages and ratios are by weight, unless specifically stated otherwise.

In this disclosure, “parts by weight” specifies the relevant proportions of components by weight.

In this disclosure, “about” means a value plus/minus 10%. For example, “about 100” means 100±10 and “about 200” means 200±20.

In this disclosure, the term “composition” may be used interchangeably with the term “mixture” or “formulation.” Compositions in this disclosure may include dry powder formulations which do not comprise water or liquid components as well as compositions in liquid, slurry or paste form which comprise water and/or liquid components.

In this disclosure, “a dry joint compound composition” means that the composition does not contain aqueous water or liquid components. Preferably, the composition may be in powder form. However, a dry composition or dry mixture may have some moisture content and may contain compounds with bound water molecules.

In this disclosure, “dry component” means a component which does not comprise aqueous water or liquid additives. The dry component may have some moisture content and may contain bound water molecules.

In this disclosure “by wt % on a dry basis of the composition” means by weight of dry components, not including aqueous water or liquid components.

In this disclosure, a drywall may be referred interchangeably as a drywall panel, plasterboard, wallboard, or gypsum board. The drywall panel is composed of a gypsum core extruded between two sheets of paper, a facer and a backer. Being rectangular in its shape, the drywall panel has two long surfaces, a first long surface covered with the facer paper sheet and the opposing second long surface covered with the backer cover sheet, for example as described in U.S. Pat. Nos. 11,002,010, 11,702,373 and/or 9,249,578.

In this disclosure, the term “limestone” may be used interchangeably with calcium carbonate or CaCO₃.

In order to measure particle sizes, approximated as diameters, a person of skill may use a particle size analyzer such as a dynamic light scattering analyzer which may be Horiba LA950V2 dynamic light scattering analyzer (Horiba, Japan) and isopropyl alcohol as dispersant. A particle size distribution in a volume can be calculated by using manufacturer's software.

In this disclosure, a median particle size may be used interchangeably with the term a median particle diameter, or “D50.” The median particle size, D50, means the average particle size in a volume of particles, and it also means that 50% of the particles in this volume are smaller than D50 and 50% of particles are larger. Thus, D50 characterizes a particle size distribution and defines the average particle size in a sample (volume) of particles.

### Self-Priming Joint Compounds and Coatings

In this disclosure, levels 0 through 5 for drywall finish are as defined by the Gypsum Association and as stated in the Gypsum Association's “Recommended Levels of Finish for Gypsum Board, Glass Mat and Fiber-Reinforced Gypsum Panels.” (GA-214). A level 4 drywall finish is typically a level used for walls to be painted, or finished with some light texturing. In order to produce a level 4 finish after drywall panels are attached to a frame, they are taped, all joints and angles are prepared with 3 layers of a joint compound and sanded. All screws, nails and accessories are also prepared with three coats of a joint compound.

At a level 5 finish, a wall of drywall panels is expected to have a smooth and uniform (monolithic) surface. Level 5 drywall finishing includes all steps of level 4 finish and further an additional step of applying a skim coat of a joint compound or primer coating evenly across the entire wall surface.

In one aspect, this disclosure relates to a joint compound with self-priming properties such that the need for using a primer coating may be avoided at least in application to a level 5 finish. A technical solution provided in this disclosure includes formulating a joint compound which when applied to a substrate, preferably a drywall panel surface, has fewer and/or smaller trapped air bubbles in comparison to substrates coated with conventional calcium carbonate comprising joint compounds. It has been unexpectedly found that using the inventive self-priming joint compound composition as a coating over a substrate, preferably a drywall surface, improves the overall porosity of the coated substrate, eliminating or minimizing the need for a primer coating before a paint coating can be applied over the substrate, and also making it possible for applying a paint coating only in one coating, rather than using 2 or more coatings of paint.

The self-priming joint compound compositions according to this disclosure have a higher packing ability and reduced porosity in comparison to conventional calcium carbonate comprising joint compounds. This technological advantage is achieved by using a combination of two fillers, a first, preferably hydrophobic, filler with a D50 in the range from about 1 μm to about 65 μm and a second, preferably hydrophilic, filler with a D50 in the range from about 0.6 μm to about 25 μm and wherein a weight ratio of the first hydrophobic filler to the second non-hydrophobic filler is in the range from about 1:2 to about 1:10 by weight.

The first filler may contain one or more of the following: glass microspheres, hollow glass microspheres, hollow glass microspheres coated with a hydrophobic coating, expanded perlite, coated expanded perlite, fly ash, ceramic spheres, synthetic light-weight fillers, or any combinations thereof. Preferably, the first hydrophobic filler may have a D50 in the range from about 18 μm to about 65 μm. In particularly preferred embodiments, the first hydrophobic filler may include hollow glass microspheres and even more preferably hollow soda-lime borosilicate glass microspheres.

In the self-priming joint compound compositions according to this disclosure, the hollow glass microspheres filler may have a median particle diameter (D50) in the range from about 18 to about 65 μm, and more preferably having a D50 of about 40 μm.

The self-priming joint compound compositions according to this disclosure may comprise the first hydrophobic filler which preferably includes hollow glass microspheres in an amount from about 2 to about 50 wt %, more preferably from about 5 to about 10 wt %, calculated as percentage by weight of all dry components in the composition.

The second, preferably hydrophilic or not-hydrophobic, filler in the self-priming joint compound compositions according to this disclosure may include one or more of the following: calcium carbonate, precipitated calcium carbonate, gypsum (calcium sulfate dihydrate and/or calcium sulfate anhydrate), mica, pyrophyllite, clay, or any combination thereof. The second hydrophilic filler may have a particle size distribution with a median particle diameter D50 of about 25 μm or less, or 14 μm or less, or 12 μm, or more preferably having a median particle diameter D50 in the range from about 0.6 μm to about 25 μm.

Preferably, the self-priming joint compound compositions according to this disclosure may comprise calcium carbonate particles, preferably calcium carbonate particles having a particle size distribution with a median particle diameter D50 of about 25 μm or less, or 14 μm or less, or 0.6 μm, or more preferably having a median particle diameter D50 in the range from about 9 μm to about 15 μm.

The self-priming joint compound compositions according to this disclosure may comprise the second non-hydrophobic filler which preferably comprises calcium carbonate particles in an amount from about 40 to about 95 wt %, more preferably from about 50 to about 70 wt %, calculated as percentage by weight of all dry components in the composition.

Suitable calcium carbonate may be in the form of a powder with a D50 of 25 μm or less, and preferably a D50 of about 12 μm and/or D97 of about 37 μm. “D97” means that 97% of particles in a sample by volume have a dimeter (size) smaller than about 37 μm.

In some embodiments, calcium carbonate may have D97 less than about 40 μm, or less than about 30 μm and/or to produce calcium carbonate powder with a D50 of 15 μm or less, and preferably a D50 of about 12 μm.

In particularly preferred embodiments in order to achieve the necessary packing of fillers, the self-priming joint compound compositions may comprise calcium carbonate particles having a particle size distribution by volume with a median particle diameter (D50) in the range from about 3 μm to about 25 μm, and more preferably having a D50 of about 12 μm in combination with hollow glass microspheres having a particle size distribution by volume with a median particle diameter (D50) in the range from about 18 to about 65 μm, and more preferably having a D50 of about 40 μm, wherein a ratio of glass microspheres to calcium carbonate particles is in the range from about 1:2 to about 1:10 by weight. The self-priming joint compound compositions according to this disclosure may comprise calcium carbonate in an amount from about 40 wt % to about 95 wt %, more preferably from about 55 to about 65 wt %, and hollow glass microspheres in an amount from about 2 to about 50 wt %, more preferably from about 5 to about 10 wt %, calculated as percentage by weight of all dry components in the composition. These inventors have found that calcium carbonate as small particles having D50 of 15 μm or less is unexpectedly suitable for producing a self-priming joint compound with improved porosity when these small calcium carbonate particles are used in combination with hollow glass microspheres, and in particular wherein a ratio of the calcium carbonate particles to the hollow glass microspheres is in the range from about 5:1 to about 10:1, and more preferably from about 7:1 to about 10:1 by weight, respectively.

Preferred hollow glass microspheres may include soda-lime borosilicate glass microspheres. In some embodiments, hollow glass microspheres, preferably soda-lime borosilicate glass microspheres may have a density in the range from about 0.30 g/cc to about 1.5 g/cc.

In some embodiments, the self-priming joint compound compositions according to this disclosure can be made as a dry formulation to which water is added by a user. In other embodiments, the self-priming joint compound compositions can be pre-mixed with water and stored and shipped as a paste or even as a liquid coating.

A third necessary component in the self-priming joint compound compositions according to this disclosure is a starch and/or a polymeric binder, preferably a latex polymeric binder, which may include one or more of the following: polyvinyl alcohol, polyvinyl acetate, acrylate, polyvinyl alcohol and polyvinyl acetate co-polymers, polyacrylamide, ethylene vinyl acetate co-polymers, vinyl or styrene acrylic co-polymers, or any combinations thereof. Suitable starches include, but are not limited to, pregelatinized starches, in particular pregelatinized corn, wheat, rice or potato starch. Suitable starches may also include acid-modified starches, in particular acid-modified corn, wheat, rice or potato starch. Starches can be used in any suitable amount and in some embodiments, from about 0.5 wt % to about 10 wt %, calculated as percentage by weight of all dry components in the composition.

In embodiments, one or more polymeric binders may be included in an amount ranging from about 0.5 wt % to about 50 wt %, preferably from about 1 wt % to about 15 wt %, calculated as percentage by weight of all dry components in the composition.

In some preferred embodiments, a polymeric binder may include a latex, such as for example as vinyl acetate ethylene emulsion which preferably may be further stabilized with polyvinyl alcohol and/or starch. In some preferred embodiments, the binder may include an acrylic emulsion binder. In some embodiments, from about 1 wt % to about 15 wt %, or from about 1 wt % to about 5 wt % of a latex emulsion, calculated as percentage by weight of all dry components in the composition.

A fourth necessary component in the self-priming compositions according to this disclosure is a thickener, which in preferred embodiments may be a cellulosic thickener. Various cellulosic thickeners can be used, including, but not limited to, cellulose ethers in which the secondary hydroxyls of cellulose are replaced by ether groups, such for example as hydroxyethyl cellulose, hydroxypropyl methylcellulose, ethylcellulose, carboxymethyl cellulose, ethyl methylcellulose, among many others; as well as various cellulose-based gums, e.g., carrageenan, guar gum, and/or xanthan gum. The cellulosic thickener may be present in any amount ranging from about 0.1 wt % to about 3 wt %, preferably from about 0.1 wt % to about 2 wt % on a dry basis of the joint compound composition. In some embodiments, one or more cellulosic thickeners may be used in amount ranging from about 0.1 to about 0.5 wt % and more preferably from about 0.1 to about 0.4 wt %, calculated as percentage by weight of all dry components in the composition.

In at least some embodiments, in addition to a cellulosic thickener, or instead of it, some other rheology modifiers can be used, including, but not limited to, clays, modified starches and/or polymeric rheology modifiers.

In some embodiments, rheology modifiers may include, but are not limited to, low molecular weight polymeric rheology modifiers which may be added in small amounts (e.g. from about 0.1 to about 5 wt %, by weight of all dry components in the composition). These low molecular weight polymeric rheology modifiers may include one or more of hydrophobically ethoxylated urethane polymers (HEUR), alkali-swellable (ASE) acrylic polymers and/or hydrophobically modified alkali swellable (HASE) acrylic co-polymers.

In some embodiments, one or more clays, including attapulgite clay and/or bentonite, and/or one or more starches can be added as a non-leveling agent in small amounts, preferably from about 1 wt % to 5 wt % by weight of all dry components in the composition.

The self-priming joint compound compositions may preferably comprise a defoamer which may be a petroleum distillate and/or it may include one or more of the following: a mixture of polysiloxanes and hydrophobic solids in polyglycol, a mixture of paraffinic mineral oils and hydrophobic components, and/or a polysiloxane which in preferred embodiments may be a polyether-modified polydimethylsiloxane. The defoamers can be used in a small amount, for example from about 0.1 wt % to about 1 wt %, calculated as percentage by weight of all dry components in the composition. For compositions in powder form, a defoamer can be provided in powder form, or if it is provided in liquid form, it can be packed separately and be added when the composition is mixed with water by a user.

The self-priming joint compound compositions according to this disclosure may further comprise one or more additives which may include at least one or more of the following: a colorant, kaolin clay, biocide, fungicide, humectant, dedusting agent, dispersing agent, a color changing indicator, or any combination thereof.

In any of the embodiments, the compositions according to this disclosure may further comprise one or more biocides and/or fungicides, which can be used in small amounts, for example, from about 0.005 wt % to about 2.0 wt %, calculated as percentage by weight of all dry components in the composition. Examples of suitable biocides include, but are not limited to, tributyltin benzoate and 2-[(hydromethyl)amino]ethanol.

In any of the embodiments, the compositions according to this disclosure may further comprise one or more of dispersing agents and/or surfactants, which can be used in small amounts, for example, from about 0.1 wt % to about 5.0 wt %, calculated as percentage by weight of all dry components in the composition. These compounds may be used as emulsion stabilizers in order to stabilize a suspension of solid components in water. Suitable dispersing agents/surfactants may include, but are not limited to nonionic surfactants having no charged groups, but anionic, cationic or amphoteric surfactants may be also used at least in some embodiments. Some preferred nonionic surfactants may include octylphenol ethoxylates and nonylphenol ethoxylates, poly(ethylene glycol) derivative in which one of the terminal hydroxy groups has been converted into the corresponding p-(2,4,4-trimethylpentan-3-yl)phenyl ether (available under trade name TRITON-X™ frp, the Dow Chemical Company), or similar compounds, and/or tall oil rosin (TOR).

In applications, where it is important to determine whether a coating is ready to be sanded, the self-priming joint compound composition may comprise a small amount, for example from about 0.1 to about 3 wt % by weight of all dry components in the composition, of a compound which changes its color when a composition has dried and is ready to be sanded. Indicators may include, but are not limited to, murexide, cresol red, m-cresol purple, bromoxylenol, thymol blue, or any combination thereof, including as described in U.S. Patent publication 2020/0156999.

The self-priming joint compound compositions according to this disclosure may comprise one or more colorants, including pigments and/or soluble dyes. Examples of colorants include, but are not limited to, zinc oxide, talc, titanium dioxide and/or carbon black. In embodiments, one or more colorants may be used in an amount from about 0.1 wt % to about 20 wt %, by weight of all dry components in the composition.

In some embodiments, joint compound compositions according to this disclosure may further comprise one or more of the following: talcs, nepheline syenite, one or more of kaolin clays and/or diatomaceous earth. These components can be used in any suitable amounts, for example in an amount from about 0.1 wt % to about 20 wt %, by weight of all dry components in the composition in some embodiments, but other concentrations may be also suitable.

In some embodiments, the compositions may include a humectant which may include a glycol, preferably, propylene glycol or ethylene glycol, but other humectants can be also used. If present, a humectant can be used in a small amount, for example, from about 0.1 wt % to about 5 wt %, by weight of all dry components in the composition.

The self-priming joint compound compositions according to this disclosure may be mixed with water and this mixture as a coating or as a paste may be applied/coated on a substrate. While the compositions can be mixed with water in any amount as may be necessary for producing a paste or a coating that can be brushed rolled or even sprayed over a surface, a coating with a high content of solids can be produced such that an amount of solids in the coating may be in the range from about 35 wt % to about 90 wt %, and more preferably about 45 to about 75 wt %. In other embodiments, for example for spray applications, more water can be used. For example, about 75 to about 35 weight parts of the composition can be used with about 25 to about 65 weight parts of water.

The self-priming joint compound compositions include compositions in powder form which are mixed with water and optionally with some other additives by a user and also ready-to-use pre-mixed compositions. Some embodiments of self-priming joint compound compositions are shown in Table 1.

TABLE 1
Self-Priming Joint Compound Composition

| | | | Most | |
|---|---|---|---|---|
| | | Preferred | Preferred | Specific |
| | Range | Range | Range | Example |
| | (Parts by | (Parts by | (Parts by | (Parts by |
| Component | Weight) | Weight) | Weight) | Weight) |
| First filler (e.g. | 2-50 | 2-50 | 5-10 | 5-10 |
| hollow glass | | | | |
| microspheres) | | | | |
| Second filler (e.g. | 40-95 | 50-70 | 55-65 | 55-65 |
| calcium carbonate) | | | | |
| Binder (e.g. Latex | 0.5-50 | 1-15 | 1-10 | 1-5 |
| Binder) | | | | |
| Thickener | 0.1-5 | 0.1-2 | 0.1-1 | 0.1-0.4 |
| (Cellulosic | | | | |
| Thickener) and | | | | |
| Rheology Modifier | | | | |
| (ASE, HASE, | | | | |
| HEUR, etc.) | | | | |
| Defoamer | 0.1-1 | 0.1-1 | 0.1-0.5 | 0.1-0.5 |
| (Petroleum | | | | |
| Distillate) | | | | |
| Biocide | 0-2 | 0-1 | 0.05-0.3 | 0.05-0.3 |
| Water | 0-65 | 0-45 | 0-35 | 0-35 |

The self-drying joint compound compositions according to this disclosure when mixed with water into a coating, have at least the following technologically advantageous features:
1) optimized filler packing and reduced porosity in comparison to traditional joint compounds;
2) optimized particle size distribution;
3) after application to a substrate, the coating produces a smooth surface;
4) the coating has an optimized latex to pigment ratio;
6) the coating is easy to sand for a smoother surface;
7) a rheology profile of the coatings is optimized for sag resistance and self-leveling;
8) a rheology profile is suitable for application by spraying, rolling, and hawk and trowel applications;
9) the coating is sufficient to ensure a sufficient enamel hold out such that it is not necessary to apply a primer coating before a paint coating can be applied;
10) the coating provides sufficient adhesion of a topcoat such that there is no need to use a primer coating;
11) in embodiments, the coating may include a color change indicator for alerting the user when the coating is dried and ready to be sanded or painted;
12) in embodiments, the composition can be formulated into a coating with a high content of solids (>60%) (range 35-90%); and
13) the coating is suitable for application over a great variety of substrates, including drywall panels, concrete, cinder block, form concrete, among others.

Thus, at least some technological advantages provided by the coatings formulated with the self-priming joint compound compositions include the coatings are suitable for equalizing the porosity of the substrate, for masking imperfections on the substrate surface, reducing a flashing, including for drywall seams and/or for improving adhesion of a subsequently applied paint coating or some other topcoat.

### Application Methods

In another aspect, this disclosure relates to methods for finishing a substrate surface, the method comprising applying at least one coating of the self-priming joint compound composition according to this disclosure mixed with water over the substrate surface, allowing the coating to dry, optionally sanding the substrate surface, and then applying a paint coating or other decorative finish.

In order to mix the coating, the self-priming joint compound compositions can be mixed with water in any amounts, preferably in a weight ratio from about 3:7 to about 9:1, respectively.

Preferably, the methods may be performed without applying a latex primer coating over the substrate. The methods can be performed with various substrates, including drywall panels, concrete, cinder block, form concrete, seams, or any combination thereof. In some embodiments, the substrate may include a drywall surface and/or a seam between adjacent drywall panels attached to a frame, optionally, the seam being filled with a conventional joint compound.

In some embodiments, the self-priming joint compound according to this disclosure may be applied to the substrate by a drywall knife, hawk and trowel, roller, brush, or by spraying.

In some embodiments, the coating according to this disclosure can be applied during installation of new interior walls and wherein the self-priming joint compound is applied directly over drywall paper cover sheets and seams (joints) fortified with one or more coats of a joint compound and preferably, also taped. In other embodiments, the self-priming joint compound can be applied over drywall panels which were previously painted or finished with wallpaper in order to prepare these drywall panels for receiving a new coat of paint.

In some further embodiments, the self-priming joint compounds according to this disclosure may be used to repair damaged interior walls, including to patch imperfections, dents or scratches on a drywall surface, or prepare a drywall surface after wallpaper was removed from the drywall surface and/or to prepare drywall seams, including masking nail heads for receiving a paint coating.

The self-priming joint compound according to this disclosure may be used in preparing a drywall surface for receiving any conventional paint coating, including, but not limited to, a latex paint coating, a water-based or solvent-based epoxy paint coating and/or alkyd/oil based paint coating.

In embodiments, the self-priming joint compound according to this disclosure can be used with flat (gloss range less than 5 of the scale from 0 to 100) or eggshell (gloss range 10-15 on the scale 0 to 100) paint coatings. However, the self-priming joint compound according to this disclosure is particularly useful in applications when a drywall surface needs to be prepared for receiving a coat of a gloss (gloss range 70-80 on the scale 0 to 100) or semi-gloss (gloss range 40-50 on the scale 0 to 100) paint coatings, which are conventionally do not adhere well to interior walls without a primer coating.

In order to measure paint gloss, a glossmeter (elcometer) which projects a beam of light at a fixed intensity and angle (e.g. 60 or 85 degrees) onto a test surface and then measures the amount of reflected light from the surface at an equal but opposite angle.

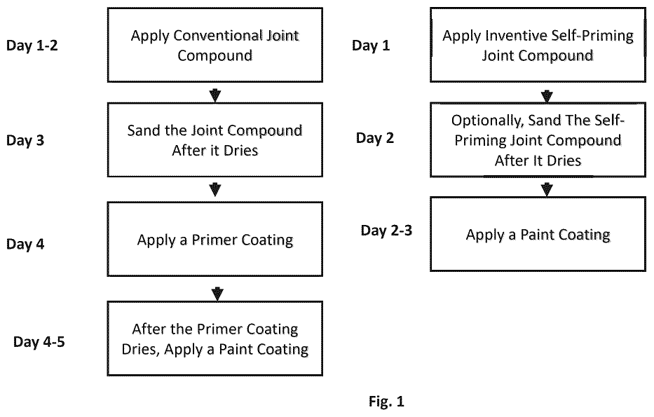

While a conventional finish of a drywall panel may require 4 to 5 days for completion as shown in FIG. 1, the left panel, using the self-priming joint compound according to this disclosure as shown in FIG. 1, the right panel, may completed in 2 to 3 days at least in some applications in which a step of applying a primer coating may be omitted because an even texture, sufficient adhesion of a paint coating and acceptable gloss can be accomplished by applying the self-priming joint compound.

With conventional joint compounds as shown in the left panel of FIG. 1, applying a primer coating may be needed in order improve adhesion and to equalize the porosity. In contrast, no separate primer coating may be needed (FIG. 1, the right column) because the self-priming joint compound improves the porosity and texture of the substrate.

### Kits

In yet another aspect, this disclosure relates to a kit which may comprise a measured amount of any of the self-priming joint compound compositions according to this disclosure and a user instruction manual providing directions for how to use the self-priming joint compound. The kits may further comprise any of the following: one or more application tools, e.g. a drywall knife, hawk and trowel, roller, brush, etc., paints, measuring cups and/or conventional joint compounds.

The invention will now be further described by the way of the following non-limiting examples.

### Example 1

A self-priming joint compound composition according to this disclosure and was prepared according to Table 1. The coating was applied over a drywall surface and was allowed to dry. Controls A through D were performed as shown in Table 2 below. All coatings were allowed to dry, and then sanded. A paint coating was applied using drawdown bars.

In order to measure paint gloss, a glossmeter (elcometer) was used at an angle of 60 or 85 degrees and the amount of reflected light was recorded in Table 2.

TABLE 2

| | | 6 mil wet | 6 mil wet |
|---|---|---|---|
| | | Eggshell | Semigloss |
| | | Paint (Gloss | Paint (Gloss |
| | | @ 60°, | @ 60°, |
| Description | Substrate | 85° GH) | 85° GH) |
| Control A | Drywall | 6.5, 11.2 | 14.2, 26.2 |
| Control B | Conventional Joint | 5.6, 9.6 | 11.8, 21.5 |
| | Compound (Plus | | |
| | 3 ™)(light weight, | | |
| | all-purpose joint | | |
| | compound, pre-mixed, | | |
| | comprises calcium | | |
| | carbonate and perlite) | | |
| | hand-applied on drywall | | |
| Control C | Drywall + 6 mil of | 7.7, 13.1 | 16.0, 31.1 |
| | Interior Vinyl Acrylic | | |
| | Primer Coating | | |
| Control D | Plus 3 ™ (light weight, | 7.6, 12.9 | 16.1, 31.5 |
| | all-purpose joint | | |
| | compound, pre-mixed, | | |
| | comprises calcium | | |
| | carbonate and perlite) | | |
| | hand-applied on | | |
| | drywall + 6 mil of | | |
| | Interior Vinyl | | |
| | Acrylic Primer Coating | | |
| The Self-Priming | The Self-Priming Joint | 8.7, 16.1 | 18.4, 36.6 |
| Joint Compound | Compound Coating | | |
| According to | according to this | | |
| This Disclosure | disclosure sprayed on | | |
| | drywall | | |

As reported in Table 2 above, the self-priming joint compound coating according to this disclosure evens the texture of a substrate and improves adhesion of a paint coating to the substrate, including of a semi-gloss paint coating, which eliminates a step of applying a primer coating before a paint coating can be applied over the substrate.

We claim:

1. A composition for a self-priming joint compound, the composition comprising:
a) a first filler having a particle size distribution with a median particle diameter (D50) in the range from about 18 μm to about 65 μm;
b) a second filler having a particle size distribution with a median particle diameter (D50) in the range from about 0.6 μm to about 25 μm;
wherein a ratio of the first filler to the second filler is in the range from 1:2 to 1:10 by weight;
c) a polymeric binder;
d) a thickener; and
e) a rheology modifier.

2. The composition of claim 1, wherein the first filler is hydrophobic, the second filler is hydrophilic and/or the composition further comprises a defoamer.

3. The composition of claim 1, wherein the first filler is in an amount from about 2 to about 50 wt %; the second filler is in an amount from about 40 to about 95 wt %; the polymeric binder in an amount from about 0.5 wt % to about 50 wt %; and the thickener and rheology modifier in an amount from about 0.05 wt % to about 5 wt %.

4. The composition of claim 1, wherein the composition further comprises a defoamer in an amount from about 0.1 wt % to about 1 wt %.

5. The composition of claim 1, wherein the first filler comprises hollow glass microspheres and/or the second filler comprises calcium carbonate particles.

6. The composition of claim 5, wherein the hollow glass microspheres are further defined by one or more of the following features:
the hollow glass microspheres are soda-lime borosilicate glass microspheres;
the hollow glass microspheres have a density in the range from about 0.30 g/cc to about 1.5 g/cc;
the hollow glass microspheres are coated with a hydrophobic coating; and/or
the hollow glass microspheres have a D50 of about 40 μm.

7. The composition of claim 1, wherein the ratio of the first filler to the second filler is about 1:8 by weight.

8. The composition of claim 1, wherein the composition further comprises one or more of the following additives: a colorant, clay, biocide, fungicide, humectant, dedusting agent, dispersing agent, a color changing indicator, or any combination thereof.

9. The composition of claim 1, wherein the polymeric binder is a latex binder or a natural binder including starch.

10. The composition of claim 1, wherein the composition further comprises water in a weight ratio of dry components to water in the range from 3:7 to 9:1, respectively.

11. A coating comprising the self-priming joint compound composition of claim 1, mixed with water in a weight ratio from about 3:7 to about 9:1, respectively.

12. A method for installation, repair and/or finishing a substrate having a surface, the method comprising a step of coating the substrate surface with the coating of claim 11.

13. The method of claim 12, wherein the substrate is a drywall panel, concrete, cinder block, form concrete, a seam between two adjacent drywall panels attached to a frame, or any combination thereof.

14. The method of claim 12, wherein the coating is applied by a drywall knife, hawk and trowel, roller, brush, or by spraying.

15. The method of claim 12, wherein after the step of applying the coating, the substrate is coated with a paint coating.

16. The method of claim 15, wherein the paint coating is a semi-gloss or gloss paint coating.

17. The method of claim 15, wherein the paint coating is a latex paint coating, a water-based or solvent-based epoxy paint coating and/or alkyd/oil-based paint coating.

18. The method of claim 12, wherein the method further comprises sanding the coating after the coating has dried.

19. A kit comprising a measured amount of the composition according to claim 1 and a user instruction manual.
